(19) United States
(12) Patent Application Publication
(10) Pub. No.: US 2020/0034451 A1
(43) Pub. Date: Jan. 30, 2020

(54) DATA DEDUPLICATION FOR ELASTIC CLOUD STORAGE DEVICES

(71) Applicant: EMC IP Holding Company LLC, Hopkinton, MA (US)

(72) Inventors: Mikhail Danilov, Saint Petersburg (RU); Kirill Zakharov, Saint Petersburg (RU)

(21) Appl. No.: 16/043,353

(22) Filed: Jul. 24, 2018

(51) Int. Cl. G06F 17/30; G06F 3/06

(52) U.S. Cl. CPC G06F 17/30159; G06F 3/0641; G06F 3/0617; G06F 3/067

(57) ABSTRACT

Facilitating data deduplication in an elastic cloud storage environment is provided herein. A system can comprise a processor and a memory that stores executable instructions that, when executed by the processor, facilitate performance of operations. The operations can comprise facilitating a replication of first data from a source storage device to a destination storage device based on a first determination that the first data is not stored at the destination storage device. Further, the operations can comprise facilitating a transmission of a set of identifying information associated with second data from the source storage device and to the destination storage device based on a second determination that the second data is stored at the destination storage device. The destination storage device can retrieve the second data locally based on the set of identifying information associated with the second data.

### TECHNICAL FIELD

The subject disclosure relates generally to data storage. More specifically, this disclosure relates to data deduplication for elastic cloud storage devices.

### BACKGROUND

Distributed storage systems and/or object storage systems can provide a wide range of storage services while achieving high scalability, availability, and serviceability. An example of such storage systems is referred to as Elastic Cloud Storage (ECS), which uses the latest trends in software architecture and development to achieve the above noted services, as well as other services.

Elastic cloud storage can implement multiple storage Application Programming Interfaces (APIs), which can include a Content-Addressable Storage (CAS) platform for data archiving, a web service that provides storage through web service interfaces, as well as others. Entities with applications that use the APIs supported can benefit from switching to elastic cloud storage. Accordingly, unique challenges exist to provide performance and processing efficiency for data retained in elastic cloud storage.

The above-described context with respect to conventional storage systems is merely intended to provide an overview of current technology, and is not intended to be exhaustive. Other contextual description, and corresponding benefits of some of the various non-limiting embodiments described herein, can become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

One or more embodiments relate to a method that can comprise determining, by a system comprising a processor, that a first storage device comprises first data and second data and that a second storage device comprises the first data. The method can also comprise facilitating, by the system, a replication of the second data at the second storage device based on a replication request from the first storage device for the replication of the second data. Further, the method can comprise facilitating, by the system, a transmission of a set of identifying information associated with the first data from the first storage device to the second storage device. The first storage device and the second storage device can be geographically distributed devices.

According to some implementations, the transmission can be a first transmission and the set of identifying information can be a first set of first identifying information. Further to these implementations, the determining can comprise facilitating a second transmission to the second storage device. The second transmission can comprise the first set of first identifying information and a second set of second identifying information associated with the second data. Further, in some implementations, facilitating the replication can comprise receiving, from the second storage device, a first indication that the second set of second identifying information is not retained at the second storage device. Alternatively, or additionally, facilitating the first transmission can comprise receiving, from the second storage device, a second indication that the first set of first identifying information is retained at the second storage device.

In accordance with some implementations, facilitating the transmission of the set of identifying information can comprise mitigating an amount of inter-zone network traffic between the first storage device and the second storage device. According to some implementations, facilitating the transmission of the set of identifying information can comprise mitigating a processing intensity of data deduplication based on sharing a fingerprint calculated for a data portion.

The set of identifying information can be a first set of first identifying information, according to some implementations, and the method can comprise maintaining, by the system and at the first storage device, the first set of first identifying information for the first data, and a second set of second identifying information for the second data. The method can also comprise maintaining, by the system and at the second storage device, the first set of first identifying information for the first data, and the second set of second identifying information for the second data.

According to some implementations, determining that a first storage device comprises first data and second data and that a second storage device comprises the first data can be in response to receiving, by the system, the replication request from the first storage device. The replication request can be a request to replicate the first data and the second data at the second storage device.

One or more embodiments can relate to a system comprising a processor and a memory that stores executable instructions that, when executed by the processor, facilitate performance of operations. The operations can comprise facilitating a replication of first data from a source storage device to a destination storage device based on a first determination that the first data is not stored at the destination storage device. Further, the operations can comprise facilitating a transmission of a set of identifying information associated with second data from the source storage device and to the destination storage device based on a second determination that the second data is stored at the destination storage device. The destination storage device can retrieve the second data locally based on the set of identifying information associated with the second data.

In accordance with some implementations, the operations can comprise accessing a data store of the destination storage device to obtain the second data based on the set of identifying information. Further to these implementations, the operations can comprise filling a placeholder location with the second data. The placeholder location can be received with the replication of first data.

The transmission can be a first transmission and the set of identifying information associated with the second data can be a first set of first identifying information. The operations can further comprise prior to facilitating the replication of first data, receiving a second transmission that comprises the first set of first identifying information and a second set of second identifying information associated with the first data. The operations can also comprise facilitating, by the system, a first conveyance of a first notification that the first set of first identifying information is retained at the destination storage device. Further, the operations can comprise facilitating, by the system, a second conveyance of a second notification that the second set of second identifying information is not retained at the destination storage device.

According to some implementations, the operations can comprise determining that a first chunk of data at the destination storage device comprises the second data. The first chunk of data can be duplicated across a second chunk of data and a third chunk of data.

In some implementations, the source storage device and the destination storage device are storage devices of an elastic cloud storage system. According to some implementations, facilitating the transmission of the set of identifying information can comprise reducing inter-zone network traffic between the source storage device and the destination storage device. Further, according to some implementations, facilitating the transmission of the set of identifying information can comprise mitigating processing intensity of data deduplication between the source storage device and the destination storage device based on sharing a fingerprint calculated for a data portion.

One or more embodiments can relate to a computer-readable storage medium comprising instructions that, in response to execution, cause a system comprising a processor to perform operations. The operations can comprise conveying, from a local storage device and to a remote storage device, a request for information related to whether the remote storage device comprises a first fingerprint calculated for a first data portion and a second fingerprint calculated for a second data portion. The operations can also comprise sending, from the local storage device and to the remote storage device, information that comprises the first data portion and a placeholder that comprises the second fingerprint. Sending the information can be based on a receipt, from the remote storage device in response to the request, that the remote storage device does not recognize the first fingerprint and recognizes the second fingerprint.

According to some implementations, the operations can comprise facilitating retrieval of the second data portion internally at the remote storage device. Further, the operations can comprise inserting the second data portion in the placeholder. A data chunk of the remote storage device can comprise the first data portion and the second data portion.

In accordance with some implementations, the operations can comprise increasing a processing efficiency based on a single calculation of the first fingerprint at both the local storage device and the remote storage device as compared to separate calculations being performed at the local storage device and the remote storage device. In some implementations, the operations can comprise deduplicating data between the local storage device and the remote storage device without copying the first data portion from the local storage device to the remote storage device.

To the accomplishment of the foregoing and related ends, the disclosed subject matter comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary

### BRIEF DESCRIPTION OF THE DRAWINGS

Various non-limiting embodiments are further described with reference to the accompanying drawings in which:

FIG. 1 illustrates an example, non-limiting, system for data deduplication for elastic cloud storage devices in accordance with one or more embodiments described herein;

FIG. 2 illustrates an example, non-limiting, block diagram representation of a system that facilitates data deduplication in accordance with one or more embodiments described herein;

FIG. 3 illustrates an example, non-limiting, block diagram representation of the system of FIG. 2 performing efficient data deduplication at the GEO level in accordance with one or more embodiments described herein;

FIG. 4 illustrates an example, non-limiting, system that performs data deduplication across one or more elastic cloud storage devices in accordance with one or more embodiments described herein;

FIG. 5 illustrates a flow diagram of an example, non-limiting, method that facilitates data deduplication in accordance with one or more embodiments described herein;

FIG. 6 illustrates a flow diagram of an example, non-limiting, method that facilitates transmitting sets of identifying information for duplication of data between storage devices in accordance with one or more embodiments described herein;

FIG. 7 illustrates a flow diagram of an example, non-limiting, method that facilitates data deduplication between two or more storage devices in accordance with one or more embodiments described herein;

FIG. 8 illustrates a flow diagram of an example, non-limiting, method that facilitates data deduplication while mitigating an amount of inter-zone network traffic and increasing a processing efficiency in accordance with one or more embodiments described herein;

FIG. 9 illustrates an example, non-limiting, computing environment in which one or more embodiments described herein can be facilitated; and

FIG. 10 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

Elastic Cloud Storage (ECS) uses cutting-edge technology to implement many of its functions. In particular, ECS uses a specific method for disk capacity management and does not solely rely on a file system. The disk space is partitioned into a set of blocks of fixed size, referred to as “chunks.” All the information, user data, and different kinds of metadata, are stored in these chunks. The chunks can be shared. For example, one chunk can contain segments of several user objects. Further, chunk content is modified in append-only mode. When a chunk becomes full (e.g., based on a defined used amount of space), the chunk is sealed. Content of sealed chunks is immutable.

There are different types of chunks, one type per capacity user. In particular, user data is stored in repository chunks (or simply repo chunks). The metadata is stored in tree-like structures, referred to as “tree chunks.” Chunks of the one or more types (e.g., repo chunks and tree chunks) are shared. For example, a repo chunk can contain segments of several user objects and a tree chunk can contain elements of several trees.

Use of repo chunks assures high write performance and capacity efficiency when storage clients only write data. When storage clients also delete data, it can cause severe internal chunk fragmentation. As a result, capacity use efficiency can become an issue. In addition, the fact that chunks are immutable does not allow implementing simple but fine-grained reclamation of unused capacity. Capacity reclamation should be implemented at the chunk level. Accordingly, after some data is deleted, the capacity the data previously occupied can be reclaimed with some delay.

ECS runs a set of storage services, which together implement business logic of storage, which is referred to as “blob service.” Blob service maintains an object table that keeps track of all objects in the system. In particular, the object table contains location information for the objects. There is also a chunk manager service that maintains a chunk table. The tables (e.g., the object table and/or the chunk table) are implemented as search trees under a multi-version concurrency control policy. These trees are large and, therefore, the major part of the one or more trees resides on hard drives. As clear from the description above, a single tree update is an expensive operation. Accordingly, trees are not updated for a single data update. Instead, the one or more trees have respective journals of data updates and, when the journal is full (e.g., based on a defined fullness level), the journal processor starts. For example, the journal processor implements bulk tree updates in order to minimize the total cost of the update. Tree journals are stored in journal chunks.

As indicated by its name, ECS is a cloud storage. The corresponding feature is called GEO since ECS supports geographically distributed setups consisting of two or more zones. GEO can be used to provide an additional protection of user data by means of replication. However, ECS does not replicate objects. The replication mechanism works at the chunk level. Namely, ECS replicates repo chunks with user data and journal chunks with system and user metadata. Chunk manager service at a replication target zone registers incoming chunks. Various services, such as blob service and chunk manager, “re-play” journals the zone receives from other zones and updates their local trees (tables).

Geographically distributed ECS arrangements maintain a global (GEO level) namespace of objects and assure strong consistency for user data. This can be achieved via defining a primary zone for the one or more objects. Normally, it is a zone that has created an object. Even after an object is fully replicated to all zones, all requests related to the object are handled by its primary zone. It is noted that each chunk has its primary zone also.

Accordingly, data deduplication is an important feature for high-end storage systems. Thus, there is a need for data deduplication in ECS, which is provided with the disclosed aspects. Data deduplication is a process that eliminates redundant copies of a data portion to reduce storage overhead.

In an example, ECS can utilize a hybrid two-level data deduplication technique. For example, inline deduplication can be utilized at the zone level Inline deduplication at the zone/cluster level has a zone-local index of data portions owned locally. The deduplication engine uses this index to detect potential candidates for deduplication. Further the hybrid two-level data deduplication can use post-process deduplication at the GEO level. Post-process deduplication at the GEO level is aligned with GEO replication. After replication of a data portion is completed, the replication destination zone uses its local index to detect potential candidates for deduplication.

However, in some cases, even with the use of the hybrid two-level data deduplication, that duplicate data portions could still require replication to a remote zone. This could be necessary because data should be maintained consistently at the chunk level (e.g., backup copy of a chunk must be complete). Meanwhile, the amount of inter-zone network traffic ECS produced can be larger. The disclosed aspects provided herein provide for efficient data deduplication with a reduction of inter-zone network traffic in ECS.

The various aspects provided herein provide resource efficient data deduplication at the GEO level in ECS. At least one advantage of the disclosed aspects is that the data deduplication can be performed with a reduction of inter-zone network traffic, as compared to traditional data deduplication techniques.

According to the various aspects, a local zone does not replicate a new data portion right away. Instead, the local zone starts with a check for existence. Also, the local zone already has a fingerprint calculated for the new data portion. The local zone requests from the remote zone, which is the replication destination zone for the data portion, whether the remote zone has the fingerprint in its zone-local index or does not have the fingerprint in its zone-local index.

If the replication destination zone does not have the fingerprint in its local index, then the local zone replicates the new data portion. Note that the deduplication engine at the destination zone's side can skip the data portion because its fingerprint just has been checked already.

If the replication destination zone does have the fingerprint in its local index, then the local zone does not replicate the new data portion. Instead, the local zone can send the placeholder description for the new data portion (e.g. location of object's segments within chunks) and the portion's fingerprint. The replication destination zone can use the fingerprint to find the local data portion to be re-used. The destination fills the placeholder received with the local data portion.

Accordingly, the disclosed aspects do not allow copying duplicate data portions from a local zone to a remote zone. Therefore, the various aspects assure reduction or mitigation of inter-zone network traffic. With the conventional hybrid data deduplication techniques, a fingerprint for a data portion is calculated two times, one time by a local zone and one time by a remote zone. With the disclosed aspects, a local zone shares a fingerprint calculated for a data portion with a remote zone and, thus, there is no need for remote zones to calculate fingerprints once again. Therefore, the various aspects can assure reduction of CPU intensity of the deduplication engine by up to two times.

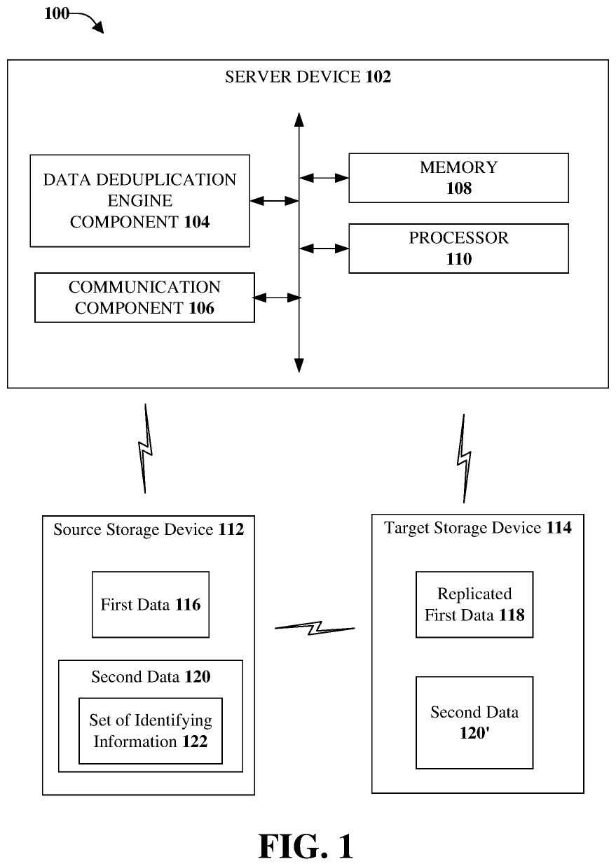

FIG. 1 illustrates an example, non-limiting, system 100 for data deduplication for elastic cloud storage devices in accordance with one or more embodiments described herein. The system 100 (as well as other systems discussed herein) can be implemented as a storage system that supports data deduplication (e.g., an elastic cloud storage). Thus, the system 100 can facilitate the deduplication of data across geographically distributed systems that comprise two or more zones.

The system 100 can include a server device 102 that can perform data deduplication among different storage zones as discussed herein. The server device 102 can include a data deduplication engine component 104, a communication component 106, at least one memory 108, and at least one processor 110. The server device 102 can interact with a source storage device 112 and a target storage device 114. Further, the source storage device 112 and the target storage device 114 can be storage devices of an ECS system. According to some implementations, the source storage device 112 can be also referred to as a first storage device or a local storage device, and the target storage device 114 can be also referred to as a second storage device or a remote storage device. It is noted that although only two storage devices are illustrated and described, the disclosed aspects can be utilized with more than two storage devices.

In some implementations, the storage devices (e.g., the source storage device 112, the target storage device 114, and subsequent storage devices) can be referred to as geographically distributed setups or zones (e.g., a first zone, a second zone, and/or subsequent zones). Further, although the server device 102 is illustrated and described as a component separate from the source storage device 112 and the target storage device 114, the server device 102 can be included, at least partially in the source storage device 112 and/or the target storage device 114. In some implementations, the storage devices (e.g., the source storage device 112, the target storage device 114, and other storage devices) can include the functionality of the server device 102. For example, the source storage device 112 can include a first server device (that includes the functionality of the server device 102) and the target storage device 114 can include a second server device (that includes the functionality of the server device 102). Accordingly, the first server device and the second server device can be in communication with one another but can operate independently from one another.

As used herein, the term “storage device,” “first storage device,” “storage system,” and the like, can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within a distributed object storage system, that are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), Flash Devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

The data deduplication engine component 104 can determine that first data 116, stored in the source storage device 112, is not stored at the target storage device 114. Based on this determination, the data deduplication engine component 104 can facilitate a replication of the first data 116 at the target storage device 114, illustrated as replicated first data 118.

The data deduplication engine component 104 can also determine that second data 120, stored in the source storage device 112, is stored at the target storage device 114, illustrated as second data 120′. Based on this determination, the communication component 106 can facilitate a transmission of a set of identifying information 122 associated with the second data 120 from the source storage device 112 to the target storage device 114. The target storage device 114 can retrieve the second data 120′ locally (e.g., internal to the target storage device 114) based on the set of identifying information 122 associated with the second data 120.

According to some implementations, by facilitating the transmission of the set of identifying information 122, the system 100 can reduce inter-zone network traffic between the source storage device 112 and the target storage device 114, as compared to previous data deduplication techniques. Additionally, in some implementations, by facilitating the transmission of the set of identifying information 122, the system 100 can reduce processing intensity of data deduplication between the source storage device 112 and the target storage device 114, as compared to previous data deduplication techniques.

As mentioned, data deduplication is a process that eliminates redundant copies of a data portion to reduce storage overhead. With deduplication, a storage system keeps a single physical copy of a data portion. All blocks, files, objects, and so on that contain the data portion simply reference the single shared copy.

There are at least two techniques for data deduplication, namely, inline deduplication and post-process deduplication Inline deduplication performs deduplication of data before the data is written to a primary storage device (e.g., a hard drive). Therefore, data deduplication works in line with data creation within a storage system. Post-process deduplication waits for data to land on a primary storage device before initiating the deduplication process. Therefore, the deduplication process can work in background mode. It is noted that the inline deduplication process creates certain inline overhead. On the other hand, post-process deduplication requires some extra capacity.

Regardless of the moment data deduplication takes place, a deduplication engine (e.g., the data deduplication engine component 104) implements a similar logic. The engine (e.g., the data deduplication engine component 104) can calculate a fingerprint (e.g., a hash value, such as MD5 algorithm) for a data portion and can compare the fingerprint to fingerprints of existing data portions. If there is a data portion with the same fingerprint, the engine (e.g., the data deduplication engine component 104) can perform deduplication.

In some cases, the storage devices (e.g., the source storage device 112 and the target storage device 114) can be included in respective storage devices, which can include one or more services and/or one or more storage devices. In some embodiments, a storage device can comprise various services including: an authentication service to authenticate requests, storage APIs to parse and interpret requests, a storage chunk management service to facilitate storage chunk allocation/reclamation for different storage system needs and monitor storage chunk health and usage, a storage server management service to manage available storage devices capacity and to track storage devices states, and a storage server service to interface with the storage devices.

Further, a storage cluster can include one or more storage devices. For example, a distributed storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

With continuing reference to the server device 102, the at least one memory 108 can be operatively coupled to the at least one processor 110. The at least one memory 108 can store protocols associated with facilitating data deduplication in a data storage environment as discussed herein. Further, the at least one memory 108 can facilitate actions to control communication between the server device 102 and the one or more storage devices (e.g., the source storage device 112, the target storage device 114), such that the system 100 can employ stored protocols and/or algorithms to achieve improved storage management through data deduplication as described herein.

It should be appreciated that data store components (e.g., memories) described herein can be either volatile memory or nonvolatile memory, or can include both volatile and nonvolatile memory. By way of example and not limitation, nonvolatile memory can include Read Only Memory (ROM), Programmable ROM (PROM), Electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to comprise, without being limited to, these and other suitable types of memory.

The at least one processor 110 can facilitate processing data related to data deduplication as discussed herein. The at least one processor 110 can be a processor dedicated to analyzing and/or generating information received, a processor that controls one or more components of the system 100, and/or a processor that both analyzes and generates information received and controls one or more components of the system 100.

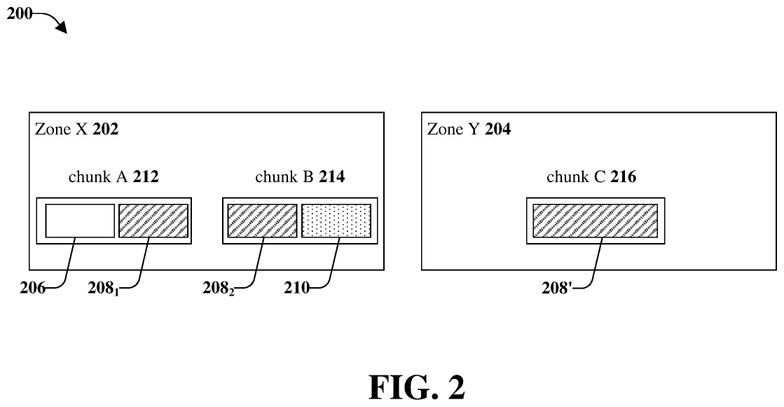

To more fully describe the various aspects, FIG. 2 illustrates an example, non-limiting, block diagram representation of a system 200 that facilitates data deduplication in accordance with one or more embodiments described herein. Repetitive description of like elements employed in other embodiments described herein is omitted for sake of brevity. The system 200 can comprise one or more of the components and/or functionality of the system 100, and vice versa.

The system 200 can perform deduplication at the object level. As illustrated, the system 200 can comprise at least two zones, illustrated as Zone X 202 and Zone Y 204. It is noted that although only two zones are illustrated and described, the various aspects can be utilized for more than two zones.

Zone X 202 comprises three objects (e.g., a first object 206, a second object 208, and a third object 210) stored to two chunks (e.g., Chunk A 212 and Chunk B 214). The second object 208 comprises two segments, labeled as a first segment 208₁ and a second segment 208₂. The first segment 208₁ occupies the second half of Chunk A 212. The second segment 208₂ occupies the first half of Chunk B 214.

Zone Y 204 comprises a single object. The single object of Zone Y 204 is identical to the second object 208 from Zone X 202 and is referred to as the second object 208 (which comprises the first segment 208₁ and the second segment 208₂). In Zone Y 204, the second object 208′ (which can comprise a first segment 208₁′ and a second segment 2082′) occupies the entirety of Chunk C 216.

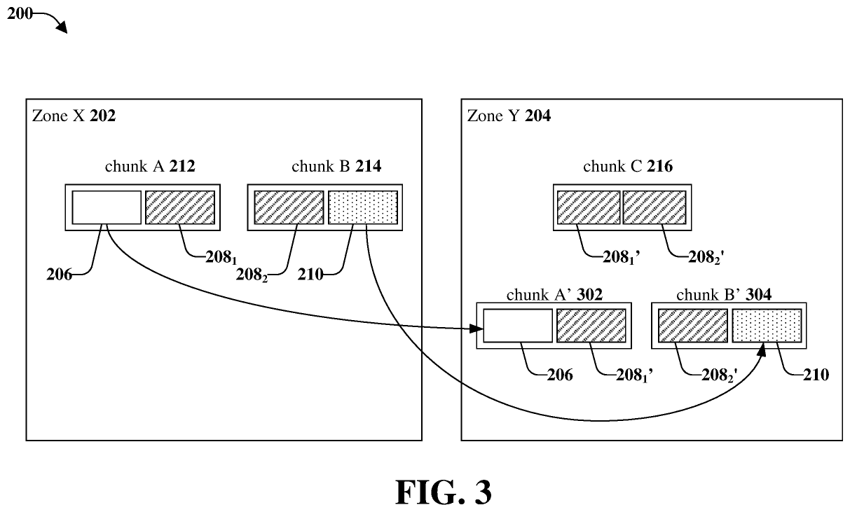

FIG. 3 illustrates an example, non-limiting, block diagram representation of the system 200 of FIG. 2 performing efficient data deduplication at the GEO level in accordance with one or more embodiments described herein. Repetitive description of like elements employed in other embodiments described herein is omitted for sake of brevity.

The replication of Chunk A 212 and Chunk B 214 to Zone Y 204 with the data deduplication discussed herein will now be described. The first object 206 and the third object 210 do not have identical objects in Zone Y 204. Therefore, the first object 206 and the third object 210 are replicated to Zone Y 204, as parts of Chunk A 212 and Chunk B 214.

When Zone X 202 performs a check for existence for the second object 208 in Zone Y 204 (e.g., via the server device 102), Zone Y 204 reports that it does contain an identical object. Therefore, Zone X 202 (e.g., via the server device 102) does not replicate the content of the second object 208 to Zone Y 204. Zone X 202 sends to Zone Y 204 the fingerprint of the second object 208 and the following placeholder:
Second half of chunk A;
First half of chunk B.

Zone Y 204 finds the identical data in Chunk C 216 (comprising the first segment 208₁′ and the second segment 208₂′) and uses this data to fill the placeholder above. The first half of Chunk C 216 (e.g., the first segment 208₁′) is copied to an end of a backup copy of Chunk A′ 302. The second half of Chunk C 216 (e.g., the second segment 2082′) is copied to a beginning of a backup copy of chunk B′ 304.

Zone Y 204 now contains complete backup copies of Chunk A 212 and Chunk B 214. However, the result was achieved without copying the second object 208 over the inter-zone network. Therefore, taking into account the fact that the second object 208 in this example has a size of a chunk, the disclosed aspects can reduce inter-zone network traffic by two times. Further, the disclosed aspects are practical to implement. In addition, the disclosed aspects can assure at least the following: (a) reduction of inter-zone network traffic and (b) reduction of CPU intensity of a data deduplication process.

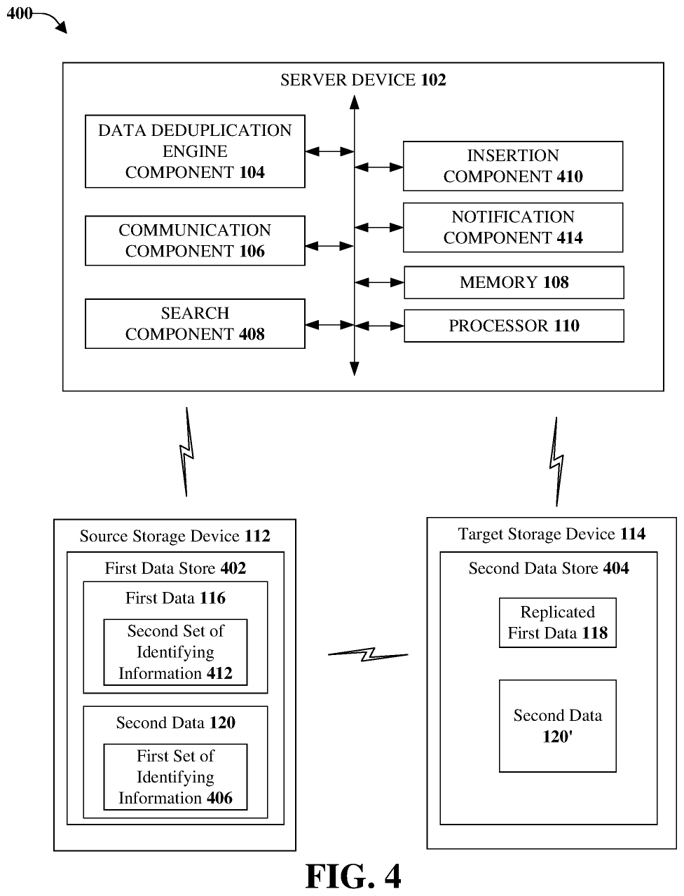

FIG. 4 illustrates an example, non-limiting, system 400 that performs data deduplication across one or more elastic cloud storage devices in accordance with one or more embodiments described herein. Repetitive description of like elements employed in other embodiments described herein is omitted for sake of brevity. The system 400 can comprise one or more of the components and/or functionality of the system 100, the system 200, and vice versa.

As illustrated, the source storage device 112 can comprise a first data store 402 and the target storage device 114 can comprise a second data store 404. The first data store 402 can comprise the first data 116, the second data 120, a first set of identifying information 406 associated with the second data 120 (e.g., the first set of identifying information 122), other data, and/or other sets of identifying information. The second data store 404 can comprise the replicated first data 118, the second data 120′, other replicated data, other data, and/or one or more sets of identifying information.

Based on a determination that the first data 116 and the second data 120 should be replicated at the target storage device 114, a search component 408 can access the second data store 404 of the target storage device 114 to obtain the second data 120′ based on the first set of identifying information 406. Since the target storage device 114 comprises the second data 120 (as second data 120′), the second data 120 does not need be sent to the target storage device 114. However, since the target storage device 114 does not comprise the first data 116. The first data 116 should be duplicated at the target storage device, as replicated first data 118.

To replicate the first data 116 and provide an indication that the second data already exists at the target storage device 114, the communication component 106 can transmit the first data 116 and a placeholder information for identifying information of the second data 120 (e.g., the first set of identifying information 406). Upon or after receipt of the transmission at the target storage device 114, an insertion component 410 can fill a placeholder location with the second data 120′. For example, the placeholder location can be received with a first transmission that comprises the replication of the first data 116.

According to some implementations, both the first data 116 and the second data 120 can already be included in the target storage device 114. Therefore, a notification component 414 can facilitate a first conveyance of a first notification that the first set of identifying information 406 is retained at the target storage device 114 (e.g., as the second data 120′). Further, the notification component 414 can facilitate a second conveyance of a second notification that the second set of second identifying information 412 is not retained at the target storage device 114. For example, the second transmission can comprise the first set of identifying information 406 and a second set of second identifying information 412 associated with the first data 116. According to these implementations, the transmission can comprise two placeholders, a first placeholder for the first set of identifying information 406 and a second placeholder for the second set of second identifying information 412.

In some implementations, the data deduplication engine component 104 can determine that a first chunk of data at the target storage device 114 comprises the second data (e.g., the second data 120′). The first chunk of data can be duplicated across a second chunk of data and a third chunk of data (e.g., as discussed with respect to Chunk A 212 and Chunk B 214).

Methods that can be implemented in accordance with the disclosed subject matter, will be better appreciated with reference to the following flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

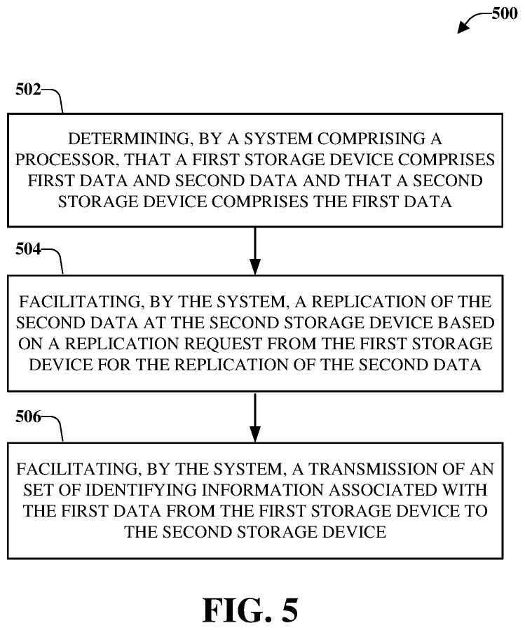

FIG. 5 illustrates a flow diagram of an example, non-limiting, method 500 that facilitates data deduplication in accordance with one or more embodiments described herein. Repetitive description of like elements employed in other embodiments described herein is omitted for sake of brevity. The method 500 can be implemented by a network device of a wireless network, the network device comprising a processor. In another example, the method 500 can be implemented by a system comprising a processor. Alternatively, or additionally, a machine-readable storage medium can comprise executable instructions that, when executed by a processor, facilitate performance of operations for the method 500.

At 502, the method 500 can determine that a first storage device comprises first data and second data and that a second storage device comprises the first data (e.g., via the search component 408). Thus, the first data is contained in both the first storage device (e.g., the source storage device 112) and the second storage device (e.g., the target storage device 114). The first storage device and the second storage device can be geographically distributed devices, according to some implementations.

Further, at 504, the method 500 can facilitate a replication of the second data at the second storage device (e.g., via the data deduplication engine component 104). The replication of the second data can be based on a replication request from the first storage device for the replication of the second data. According to some implementations, the replication of the second data can be based on a determination that the second data is not contained in the second storage device.

A transmission of a set of identifying information associated with the first data can be transmitted, at 506, from the first storage device to the second storage device (e.g., via the communication component 106). According to some implementations, facilitating the transmission of the set of identifying information can comprise mitigating an amount of inter-zone network traffic between the first storage device and the second storage device. In some implementations, facilitating the transmission of the set of identifying information can comprise mitigating a processing intensity of data deduplication based on sharing a fingerprint calculated for a data portion.

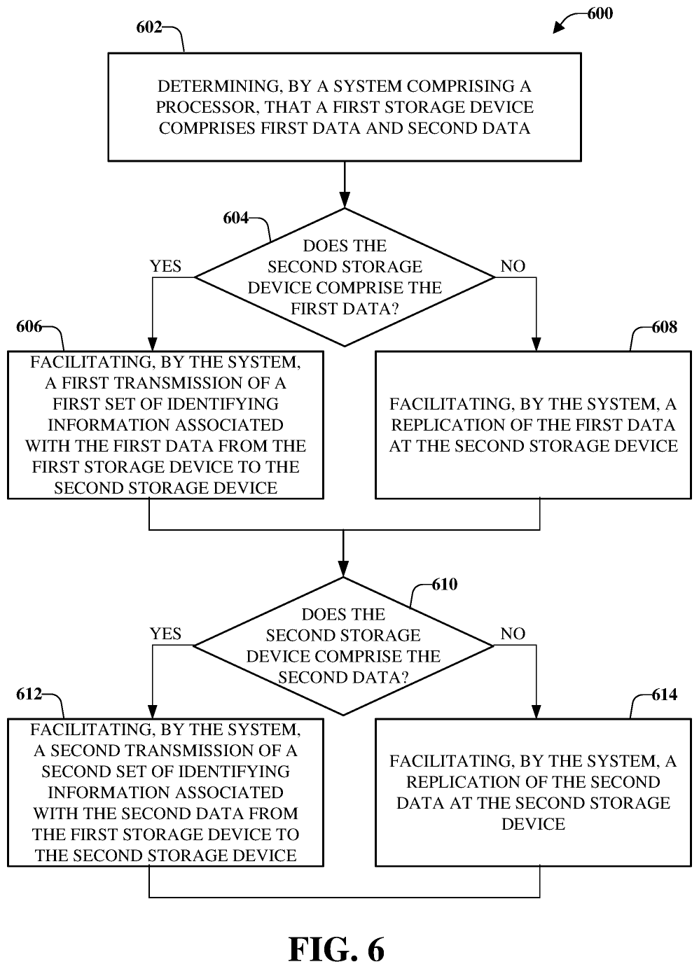

FIG. 6 illustrates a flow diagram of an example, non-limiting, method 600 that facilitates transmitting sets of identifying information for duplication of data between storage devices in accordance with one or more embodiments described herein. Repetitive description of like elements employed in other embodiments described herein is omitted for sake of brevity. The method 600 can be implemented by a network device of a wireless network, the network device comprising a processor. In another example, the method 600 can be implemented by a system comprising a processor. Alternatively, or additionally, a machine-readable storage medium can comprise executable instructions that, when executed by a processor, facilitate performance of operations for the method 600.

At 602, it can be determined that a first storage device comprises first data and second data (e.g., via the search component 408). At 604, a first determination can be made whether a second storage device comprises the first data (e.g., via the search component 408). If the second storage device does comprise the first data (“YES”), at 606, a first transmission of a first set of identifying information associated with the first data is transmitted from the first storage device to the second storage device (e.g., via the communication component 106). Alternatively, if the determination at 604 is that the second storage device does not comprise the first data (“NO”), at 608, a replication of the first data at the second storage device can be facilitated (e.g., via the data deduplication engine component 104).

Further, at 610, a second determination can be made whether the second storage device comprises the second data (e.g., via the search component 408). If the second storage device does comprise the second data (“YES”), at 612, a second transmission of a second set of identifying information associated with the second data can be transmitted from the first storage device to the second storage device (e.g., via the communication component 106). Alternatively, if the determination at 610 is that the second storage device does not comprise the second data (“NO”), at 614, a replication of the second data at the second storage device can be facilitated (e.g., via the data deduplication engine component 104).

It is noted that although illustrated and described with respect to a first transmission and a second transmission, and to separate replications of the first data and/or the second data, the transmissions and/or replications (at 606, 608, 612, and/or 614) can be combined. For example, a single transmission can be sent that includes identifying information (placeholder information) and/or replication of data.

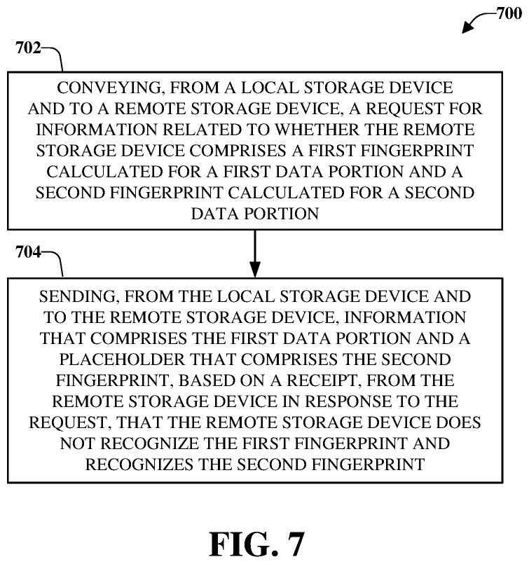

FIG. 7 illustrates a flow diagram of an example, non-limiting, method 700 that facilitates data deduplication between two or more storage devices in accordance with one or more embodiments described herein. Repetitive description of like elements employed in other embodiments described herein is omitted for sake of brevity. The method 700 can be implemented by a network device of a wireless network, the network device comprising a processor. In another example, the method 700 can be implemented by a system comprising a processor. Alternatively, or additionally, a machine-readable storage medium can comprise executable instructions that, when executed by a processor, facilitate performance of operations for the method 700.

At 702, the method 700 can convey, from a local storage device and to a remote storage device, a request for information related to whether the remote storage device comprises a first fingerprint calculated for a first data portion and a second fingerprint calculated for a second data portion (e.g., via the communication component 106). For example, the conveyance of the request can be based on a determination that the data in the local storage device should be duplicated in the remote storage device.

At 704, information that comprises the first data portion and a placeholder that comprises the second fingerprint can be sent from the local storage device and to the remote storage device. This information can be sent based on a receipt, from the remote storage device in response to the request, that the remote storage device does not recognize the first fingerprint and recognizes the second fingerprint. However, it should be understood that the remote storage device could recognize the first fingerprint and not recognize the second fingerprint. In another example, the remote storage device could recognize both the first fingerprint and the second fingerprint. In yet another example, the remote storage device might not recognize neither the first fingerprint nor the second fingerprint. By not recognizing a fingerprint, it indicates the data associated with the fingerprint is not stored in the remote storage device. Based on recognition of the fingerprint, it indicates the data associated with the fingerprint is stored in the remote storage device.

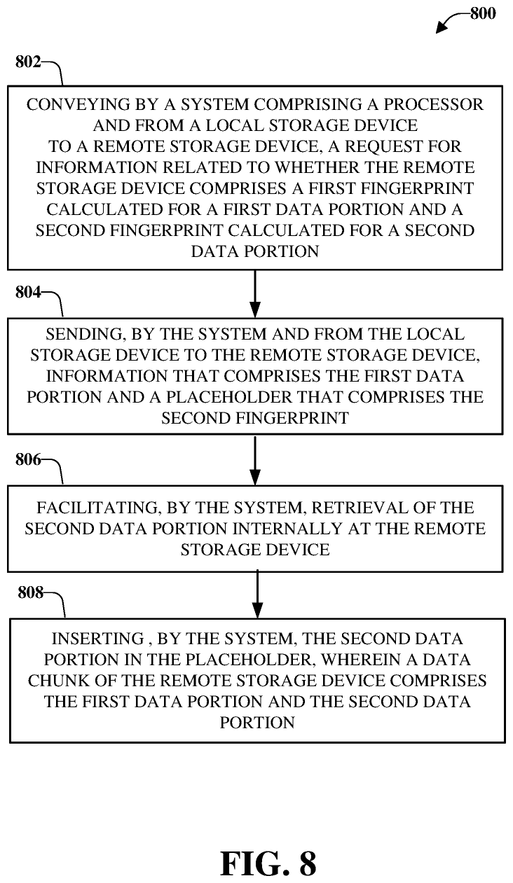

FIG. 8 illustrates a flow diagram of an example, non-limiting, method 800 that facilitates data deduplication while mitigating an amount of inter-zone network traffic and increasing a processing efficiency in accordance with one or more embodiments described herein. Repetitive description of like elements employed in other embodiments described herein is omitted for sake of brevity. The method 800 can be implemented by a network device of a wireless network, the network device comprising a processor. In another example, the method 800 can be implemented by a system comprising a processor. Alternatively, or additionally, a machine-readable storage medium can comprise executable instructions that, when executed by a processor, facilitate performance of operations for the method 800.

The method 800 can start, at 802, when a request for information can be conveyed from a local storage device to a remote storage device (e.g., via the communication component 106). The request for information can be a request for information related to whether the remote storage device comprises a first fingerprint calculated for a first data portion and a second fingerprint calculated for a second data portion.

At 804, the method 800 can send, from the local storage device and to the remote storage device, information that comprises the first data portion and a placeholder that comprises the second fingerprint (e.g., via the insertion component 410 and the notification component 414). The determination of whether to send the first data portion and/or the placeholder can be based on a receipt, from the remote storage device in response to the request, that the remote storage device does not recognize the first fingerprint and recognizes the second fingerprint.

Further, at 806, the method 800 can facilitate retrieval of the second data portion internally at the remote storage device (e.g., via the insertion component 410). For example, the second data (e.g., the second data 120′) can be retrieved from a data storage (e.g., the second data store 404) of the remote storage device. At 808, the second data portion can be inserted into the placeholder location. Accordingly, a data chunk of the remote storage device can comprise the first data portion and the second data portion.

Thus, the method 800 (as well as other embodiments discussed herein) can increase a processing efficiency based on a single calculation of the first fingerprint at both the local storage device and the remote storage device as compared to separate calculations at the local storage device and the remote storage device. Further, the method 800 (as well as other embodiments discussed herein) can deduplicate data between the local storage device and the remote storage device without copying the first data portion from the local storage device to the remote storage device (or other data that is already included on both storage devices). In addition, the method 800 (as well as other embodiments discussed herein) can reduce inter-zone network traffic between the source storage device and the destination storage device. Further, based on facilitating the transmission of the set of identifying information, the method 800 (as well as other embodiments discussed herein) can mitigate processing intensity of data deduplication between the source storage device and the destination storage device based on sharing a fingerprint calculated for a data portion.

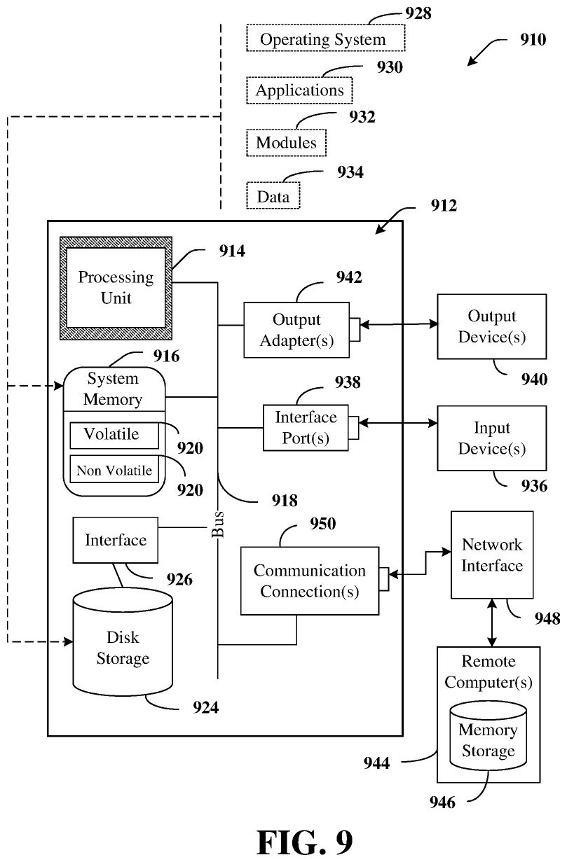

In order to provide a context for the various aspects of the disclosed subject matter, FIG. 9 as well as the following discussion are intended to provide a brief, general description of a suitable environment in which the various aspects of the disclosed subject matter can be implemented.

With reference to FIG. 9, an example environment 910 for implementing various aspects of the aforementioned subject matter comprises a computer 912. The computer 912 comprises a processing unit 914, a system memory 916, and a system bus 918. The system bus 918 couples system components including, but not limited to, the system memory 916 to the processing unit 914. The processing unit 914 can be any of various available processors. Multi-core microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 comprises volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can comprise read only memory (ROM), programmable ROM (PROM), electrically programmable ROM (EPROM), electrically erasable PROM (EEPROM), or flash memory. Volatile memory 920 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also comprises removable/non-removable, volatile/non-volatile computer storage media. FIG. 9 illustrates, for example a disk storage 924. Disk storage 924 comprises, but is not limited to, devices like a magnetic disk drive, floppy disk drive, tape drive, Jaz drive, Zip drive, LS-100 drive, flash memory card, or memory stick. In addition, disk storage 924 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used such as interface 926.

It is to be appreciated that FIG. 9 describes software that acts as an intermediary between users and the basic computer resources described in suitable operating environment 910. Such software comprises an operating system 928. Operating system 928, which can be stored on disk storage 924, acts to control and allocate resources of the computer 912. System applications 930 take advantage of the management of resources by operating system 928 through program modules 932 and program data 934 stored either in system memory 916 or on disk storage 924. It is to be appreciated that one or more embodiments of the subject disclosure can be implemented with various operating systems or combinations of operating systems.

A user enters commands or information into the computer 912 through input device(s) 936. Input devices 936 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 comprise, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapters 942 are provided to illustrate that there are some output devices 940 like monitors, speakers, and printers, among other output devices 940, which require special adapters. The output adapters 942 comprise, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically comprises many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5 and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the system bus 918. While communication connection 950 is shown for illustrative clarity inside computer 912, it can also be external to computer 912. The hardware/software necessary for connection to the network interface 948 comprises, for exemplary purposes only, internal and external technologies such as, modems including regular telephone grade modems, cable modems and DSL modems, ISDN adapters, and Ethernet cards.

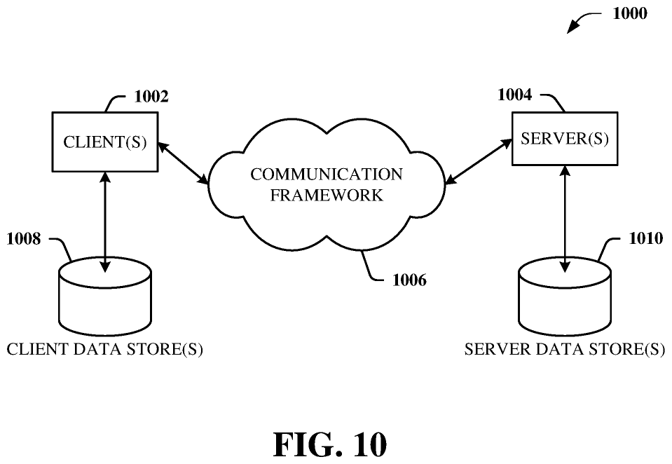

FIG. 10 is a schematic block diagram of a sample computing environment 1000 with which the disclosed subject matter can interact. The sample computing environment 1000 includes one or more client(s) 1002. The client(s) 1002 can be hardware and/or software (e.g., threads, processes, computing devices). The sample computing environment 1000 also includes one or more server(s) 1004. The server(s) 1004 can also be hardware and/or software (e.g., threads, processes, computing devices). The servers 1004 can house threads to perform transformations by employing one or more embodiments as described herein, for example. One possible communication between a client 1002 and servers 1004 can be in the form of a data packet adapted to be transmitted between two or more computer processes. The sample computing environment 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

Disclosed embodiments and/or aspects should neither be presumed to be exclusive of other disclosed embodiments and/or aspects, nor should a system, apparatus, method, computer-readable storage medium and/or the like be presumed to be exclusive to its depicted elements in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single system or apparatus achieving aggregate functionality, where suitable, or distribution of functionality of a single system or apparatus into multiple systems or apparatuses, where suitable. In addition, incorporation, combination or modification of systems, apparatuses, methods, computer-readable storage mediums and/or the like depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising a processor, that a first storage device comprises first data and second data and that a second storage device comprises the first data;
facilitating, by the system, a replication of the second data at the second storage device based on a replication request from the first storage device for the replication of the second data; and
facilitating, by the system, a transmission of a set of identifying information associated with the first data from the first storage device to the second storage device.

2. The method of claim 1, wherein the transmission is a first transmission, and wherein the set of identifying information is a first set of first identifying information, and wherein the determining comprises facilitating a second transmission to the second storage device, the second transmission comprises the first set of first identifying information and a second set of second identifying information associated with the second data.

3. The method of claim 2, wherein the facilitating the replication comprises receiving, from the second storage device, a first indication that the second set of second identifying information is not retained at the second storage device.

4. The method of claim 2, wherein the facilitating the first transmission comprises receiving, from the second storage device, a second indication that the first set of first identifying information is retained at the second storage device.

5. The method of claim 1, wherein the first storage device and the second storage device are geographically distributed devices.

6. The method of claim 1, wherein the facilitating the transmission of the set of identifying information comprises mitigating an amount of inter-zone network traffic between the first storage device and the second storage device.

7. The method of claim 1, wherein the facilitating the transmission of the set of identifying information comprises mitigating a processing intensity of data deduplication based on sharing a fingerprint calculated for a data portion.

8. The method of claim 1, wherein the set of identifying information is a first set of first identifying information, and the method further comprises:
maintaining, by the system and at the first storage device, the first set of first identifying information for the first data, and a second set of second identifying information for the second data; and
maintaining, by the system and at the second storage device, the first set of first identifying information for the first data, and the second set of second identifying information for the second data.

9. The method of claim 1, wherein the determining is in response to:
receiving, by the system, the replication request from the first storage device to replicate the first data and the second data at the second storage device.

10. A system, comprising:
a processor; and
a memory that stores executable instructions that, when executed by the processor, facilitate performance of operations, comprising:
facilitating a replication of first data from a source storage device to a destination storage device based on a first determination that the first data is not stored at the destination storage device; and
facilitating a transmission of a set of identifying information associated with second data from the source storage device and to the destination storage device based on a second determination that the second data is stored at the destination storage device, wherein the destination storage device retrieves the second data locally based on the set of identifying information associated with the second data.

11. The system of claim 10, wherein the operations further comprise:
accessing a data store of the destination storage device to obtain the second data based on the set of identifying information; and
filling a placeholder location with the second data, wherein the placeholder location is received with the replication of first data.

12. The system of claim 10, wherein the transmission is a first transmission, and wherein the set of identifying information associated with the second data is a first set of first identifying information, and the operations further comprising:
prior to the facilitating the replication of first data, receiving a second transmission that comprises the first set of first identifying information and a second set of second identifying information associated with the first data;
facilitating, by the system, a first conveyance of a first notification that the first set of first identifying information is retained at the destination storage device; and
facilitating, by the system, a second conveyance of a second notification that the second set of second identifying information is not retained at the destination storage device.

13. The system of claim 12, wherein the operations further comprise:
determining that a first chunk of data at the destination storage device comprises the second data, and wherein the first chunk of data is duplicated across a second chunk of data and a third chunk of data.

14. The system of claim 10, wherein the source storage device and the destination storage device are storage devices of an elastic cloud storage system.

15. The system of claim 10, wherein the facilitating the transmission of the set of identifying information comprises reducing inter-zone network traffic between the source storage device and the destination storage device.

16. The system of claim 10, wherein the facilitating the transmission of the set of identifying information comprises mitigating processing intensity of data deduplication between the source storage device and the destination storage device based on sharing a fingerprint calculated for a data portion.

17. A computer-readable storage medium comprising instructions that, in response to execution, cause a system comprising a processor to perform operations, comprising:
conveying, from a local storage device and to a remote storage device, a request for information related to whether the remote storage device comprises a first fingerprint calculated for a first data portion and a second fingerprint calculated for a second data portion; and
sending, from the local storage device and to the remote storage device, information that comprises the first data portion and a placeholder that comprises the second fingerprint, based on a receipt, from the remote storage device in response to the request, that the remote storage device does not recognize the first fingerprint and recognizes the second fingerprint.

18. The computer-readable storage medium of claim 17, wherein the operations further comprise:
facilitating retrieval of the second data portion internally at the remote storage device; and
inserting the second data portion in the placeholder, wherein a data chunk of the remote storage device comprises the first data portion and the second data portion.

19. The computer-readable storage medium of claim 17, wherein the operations further comprise increasing a processing efficiency based on a single calculation of the first fingerprint at both the local storage device and the remote storage device as compared to separate calculations at the local storage device and the remote storage device.

20. The computer-readable storage medium of claim 17, wherein the operations further comprise:
deduplicating data between the local storage device and the remote storage device without copying the first data portion from the local storage device to the remote storage device.
